(19) United States
(12) Patent Application Publication
(10) Pub. No.: US 2008/0292304 A1
(43) Pub. Date: Nov. 27, 2008

(54) Projection Type Image Display Apparatus And Projection Type Image Display System

(75) Inventor: Shinichi HIRAI, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/124,078

(22) Filed: May 20, 2008

(30) Foreign Application Priority Data
May 22, 2007 (JP) 2007-135523

(51) Int. Cl. G03B 21/00

(52) U.S. Cl. 396/430

(57) ABSTRACT

Disclosed is a projection type image display apparatus including a projection section, a photographing section, a zoom changing section, a projection position changing section and a control section, and when an image is projected on the screen which includes a projection region of a predetermined size and which has a first mark image at a portion of the projection region, the control section controls the projection section so as to project an image which includes a second mark image matching with the first mark image when the projected image is displayed by being matched with the projection region, the control section controls the photographing section so as to photograph the first mark image and the second mark image which is in the projected image, and the control section adjusts the size and the projection position of the projected image based on the first mark image and the second mark image.

### BACKGROUND OF THE INVENTION

1. Field of the Invention

The present invention relates to a projection type image display apparatus and a projection type image display system, each provided with a photographing section capable of photographing a projected image projected on a screen through a projector lens to adjust the focus, the size and the position of the projected image by using the photographing section.

2. Description of Related Art

A conventional projection type projector which modulates the light emitted from a light source with an image projecting device such the DMD or the like and which projects the modulated light onto a screen through an optical lens (projector lens) to display an image is known.

Because it is troublesome for a user to manually adjust the focus of a projected image in the projection type projector, a projection type projector equipped with the so-called autofocus function for automatically adjusting the focus of a projected image has been provided. For example, there is developed a projector apparatus which has a function of automatically adjusting the focus by automatically measuring a distance to a screen and by displacing the position of the projector lens by the internal control processing on the basis of the measured value.

Moreover, in a general projection type projector, the position of a projected image is adjusted by a user adjusting the direction and the inclination of the apparatus so that a projected image is displayed in a desired region on a screen.

Moreover, the following techniques are disclosed as related art pertaining to the present invention.

For example, JP2006-098789A discloses a technique of attaching a plurality of points on a screen and picking up these points to correct the size and the like of a projected image on the basis of the plurality of points. Moreover, JP2003-015218A discloses the technique of arranging a plurality of marks on a screen and picking up the marks with an omnidirectional camera to calculate the direction of the screen and the distance to the screen.

In a projection type projector, it is a troublesome operation for a user to manually adjust the position and the size of a projected image and to manually adjust the focus of the projected image. Moreover, the technique of automatically measuring the distance between a screen and a projection type projector to perform focus adjustment as in the related art mentioned above has a problem such that the kinds of screen to be used are limited in order to perform accurate distance measurement.

### SUMMARY OF THE INVENTION

It is, therefore, a main object of the present invention to provide a projection type image display apparatus and a projection type image display system which are capable of automatically and accurately adjusting the position, the size and the focus of a projected image without troubling a user and which are capable of accommodating various situations in such that the kinds of screen to be used is not limited.

According to a first aspect of the present invention, there is provided a projection type image display apparatus comprising a projection section to output a projection light in which an image is attached through a projector lens, a photographing section to photograph a projected image projected by the projection section through a photographing lens, a zoom changing section to change a size of the projected image, a projection position changing section to change a projection position of the projected image and a control section to control the zoom changing section and the projection position changing section to adjust the size and the projection position of the projected image which is projected onto a screen, and when an image is projected on the screen which includes a projection region of a predetermined size and which has a first mark image at a portion of the projection region, the control section controls the projection section so as to project an image which includes a second mark image matching with the first mark image when the projected image is displayed by being matched with the projection region, the control section controls the photographing section so as to photograph the first mark image and the second mark image which is in the projected image, and the control section adjusts the size of the projected image by comparing a size of the first mark image and a size of the second mark image, the first mark image and the second mark image being obtained by the photographing section, and adjusts the projection position of the projected image by comparing a position of the first mark image and a position of the second mark image.

According to a second aspect of the present invention, there is provided a projection type image display apparatus comprising a projection section to output a projection light in which an image is attached through a projector lens, a photographing section to photograph a projected image projected by the projection section through a photographing lens, a zoom changing section to change a size of the projected image, a projection position changing section to change a projection position of the projected image, a lens position changing section which can change a lens position of the projector lens so that the projected image is in focus and a control section to control the zoom changing section, the projection position changing section and the lens position changing section to adjust the size, the projection position and a focus of the projected image projected on a screen, and when an image is projected on the screen which includes a projection region of a predetermined size and in which two first mark images have each pattern where bright parts and dark parts are alternately arranged are provided on a diagonal line by having a center of the projection region in between the two first mark images, the control section controls the projection section so as to project an image which includes a second mark image matching with the first mark image when the projected image is displayed by being matched with the projection region, the control section controls the photographing section so as to photograph the first mark image and the second mark image which are in the projected image, the control section adjusts the size of the projected image by comparing the area of the bright parts of the first mark image to the area of the bright part of the second mark image or by comparing the area of the dark parts of the first mark image to the area of the dark parts of the second mark image, the first mark image and the second mark image being obtained by the photographing section, and the control section adjusts the projection position of the projected image by comparing coordinates of boundary points of the bright parts and the dark parts of the first mark image to coordinates of boundary points of the bright parts and the dark parts of the second mark image, the first mark image and the second mark image being obtained by the photographing section.

According to a third aspect of the present invention, there is provided a projection type image display system comprising a projection type image display apparatus comprising a projection section to output a projection light in which an image is attached through a projector lens, a photographing section to photograph a projected image projected by the projection section through a photographing lens, a zoom changing section to change a size of the projected image, a projection position changing section to change a projection position of the projected image and a control section to control the zoom changing section and the projection position changing section to adjust the size and the projection position of the projected image projected onto a screen and the screen which includes a projection region of a predetermined size and which has a first mark image at a portion of the projection region, and the control section controls the projection section so as to project an image which includes a second mark image matching with the first mark image when the projected image is displayed by being matched with the projection region, the control section controls the photographing section so as to photograph the first mark image and the second mark image which is in the projected image, and the control section adjusts the size of the projected image by comparing a size of the first mark image to a size of the second mark image, the first mark image and the second mark image being obtained by the photographing section, and adjusts the projection position of the projected image by comparing a position of the first mark image to a position of the second mark image.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a perspective view of the external appearance of a projection type projector according to an embodiment of the present invention;

FIG. 2 is a block diagram showing a schematic configuration of the projection type projector of the embodiment;

FIG. 3 is a flowchart showing an example of the projection control processing to be executed by the CPU of the projection type projector;

FIG. 4 is a flowchart showing an example of the focus adjustment processing;

FIG. 5 is a flowchart showing an example of the zoom adjustment processing;

FIG. 6 is a flowchart showing an example of the position adjustment processing;

FIG. 7 is an explanatory diagram showing an example of a state where an image including the second mark images is projected by a projection section 1;

FIG. 8 is an explanatory diagram showing an example of a projected image after the zoom adjustment processing is performed; and

FIG. 9 is an explanatory diagram showing an example of a projected image after the projection position adjustment processing is performed.

### DESCRIPTION OF THE PREFERRED EMBODIMENT

Hereinafter, an embodiment of the present invention will be described with reference to the drawings.

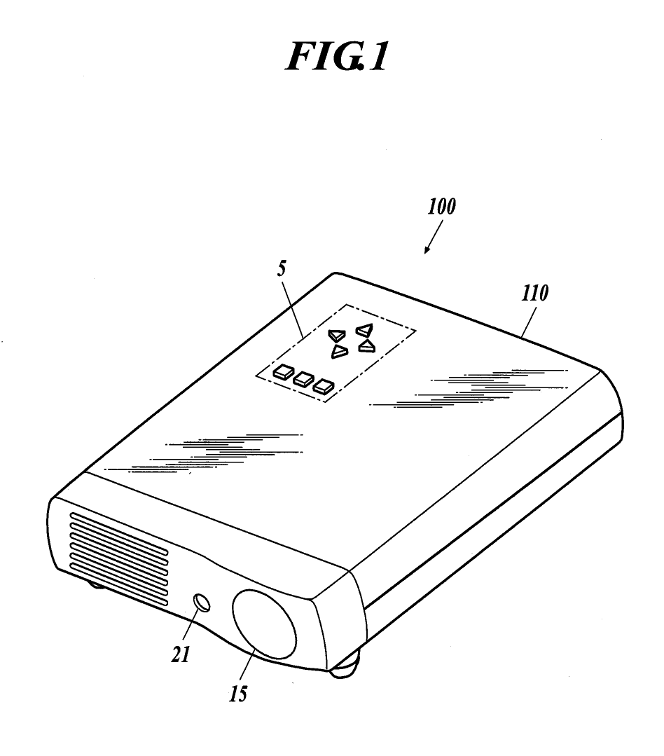

FIG. 1 is a perspective view of the external appearance of a projection type projector according to an embodiment of the present invention. As shown in FIG. 1, a projection type projector 100 according to the embodiment includes a projector lens 15 and a photographing lens 21 which are disposed at the right side in the front surface of a body case 110 shaped in a rectangular parallelepiped shape.

The projector lens 15 projects a light figure formed by a light modulation element such as the after mentioned DMD to an object such as a screen, and can arbitrarily change the focus position (lens position).

The photographing lens 21 photographs a projected image projected by the projector lens 15, and can arbitrarily change the focus position (lens position) in a similar way as the projector lens 15. Here, in the embodiment, a photographing lens having a sufficiently large depth of focus (depth of field) is used to make it easy to bring the projected image (screen surface) into focus.

Moreover, an operation section 5 equipped with various types of operation keys is provided on the upper surface of the body case 110, and an image input and output terminal and an AC adapter connection section which are not shown in the drawing are provided on the back surface of the body case 110.

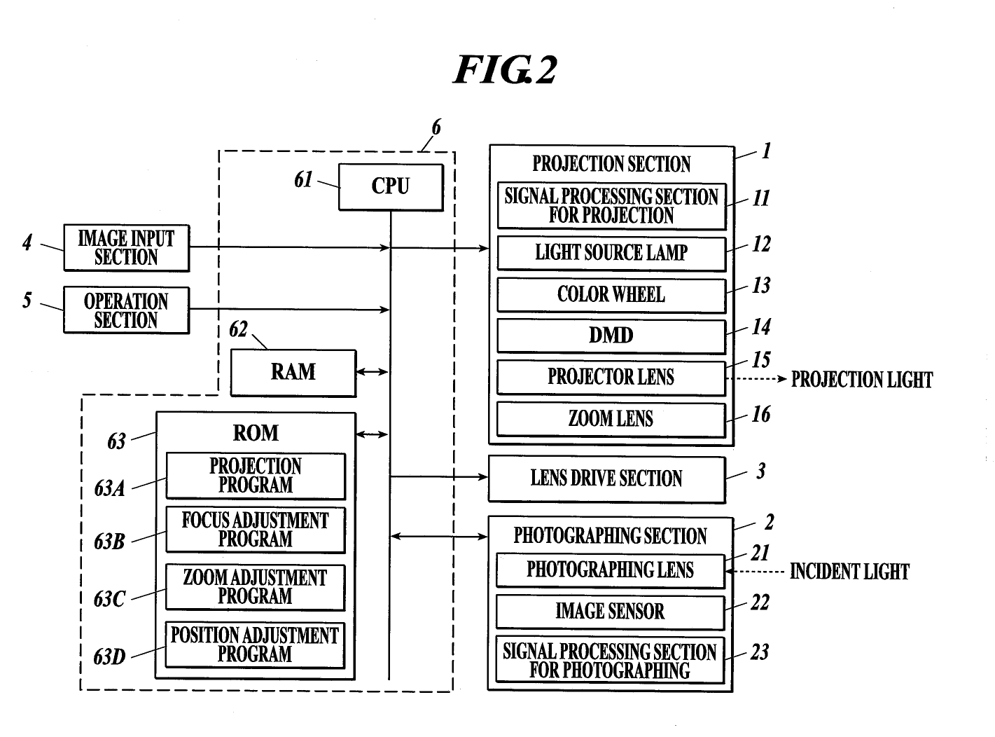

FIG. 2 is a block diagram showing the schematic configuration of the projection type projector 100 of the embodiment.

The projection type projector 100 of the embodiment is an apparatus to project a light in which an image is attached onto a screen to perform an image display, and comprises a projection section 1, a photographing section 2, a lens drive section 3, an image input section 4, the operation section 5 and a control section 6.

The projection section 1 as a projection unit comprises a signal processing section 11 for projection, a light source lamp 12, a color wheel 13, the DMD (Digital Micromirror Device) 14, the projector lens 15 and a zoom lens 16.

Particularly, the signal processing section 11 for projection generates an image signal for projection on the basis of the image data from the image input section 4. The light source lamp 12 is a light source lamp such as a metal halide lamp, an extra-high pressure mercury lamp, an incandescent lamp, a halogen lamp or the like, and is preferably a light source lamp having higher luminance and higher efficiency. The color wheel 13 is a rotating type divided color filter to change a projection light from the light source lamp 12 into any one of the monochromatic lights of R (red), G (green) and B (blue). A synchronous circuit which is not shown in the drawing is connected to the color wheel 13, and the color wheel 13 is controlled to rotate by the synchronous circuit. The DMD 14 is an approximately rectangular optical device equipped with the IC (integrated circuit) which is paved with hundreds of thousands to several millions of micromirrors, for example, and reflects light by a dot unit on the basis of the image data from the image input section 4 to generate the projection light in which an image is attached. The projector lens 15 and the zoom lens 16 project the light (optical image) modulated by the DMD 14 on the screen so that the image is enlarged.

That is, in the projection section 1, a light radiated from the light source lamp 12 is changed to any one of the monochromatic lights of R, G, and B by the color wheel 13, and the monochromatic light is modulated by the DMD 14. Then, the modulated optical image is enlarged and projected onto the screen by the projector lens 15 and the zoom lens 16.

The photographing section 2 as a photographing unit comprises the photographing lens 21, an image sensor 22 and a signal processing section 23 for photographing.

Particularly, the photographing lens 21 takes in a projected image projected on the screen by the projection section 1. The image sensor 22 is composed of an image pick-up device such as the CCD (charge coupled device), and picks up the image taken in by the photographing lens 21. The signal processing section 23 for photographing digitizes an analog image signal output from the image sensor 22 to generate an image data.

That is, in the photographing section 2, the image based on an incident light taken in through the photographing lens 21 is picked up by the image sensor 22, and the image is changed to data form by the signal processing section 23 for photographing.

The lens drive section 3 displaces the position of the projector lens 15 at the time of adjusting the focus of a projected image (lens position changing device). Moreover, the lens drive section 3 displaces the position of the zoom lens 16 at the time of changing the size of the projected image (zoom changing device). Moreover, the lens drive section 3 displaces the positions of the projector lens 15 and the zoom lens 16 at the time of changing the projection position of the projected image (projection position changing device).

For example, the image input section 4 is electrically connected to the image output equipment such as a personal computer or the like, and performs the signal processing of inputting the image data of an image to be projected onto the screen. The operation section 5 includes a plurality of operation keys relating to the turning on/off of an apparatus power source and the projection processing of an image, and enables a user to input an operation command.

For example, the control section 6 comprises the CPU (central processing unit) 61, the RAM (random access memory) 62 and the ROM (read only memory) 63, and controls each section of the projection type projector 100.

The CPU 61 reads the processing programs and the like stored in the ROM 63 and expands the read processing programs and the like in the RAM 62 to execute them. The CPU 61 thereby controls the entire projection type projector 100.

The RAM 62 expands the processing programs and the like which are executed by the CPU 61 into a program storage region in the RAM 62, and stores the input data, the processing results generated at the time of the execution of the processing programs and the like in the data storage region in the RAM 62.

For example, the ROM 63 is composed of a semiconductor memory, and the processing programs, data and the like are stored in advance. For example, the ROM 63 stores a projection program 63A to project the image based on the image data input from the image input section 4 onto the screen, a focus adjustment program 63B to adjust the focus of the projected image, a zoom adjustment program 63C to adjust the size of the projected image, a projection position adjustment program 63D to adjust the projection position of the projected image and the like.

According to the projection type projector 100 of the embodiment, when an image is projected on a specific screen, the focus, the size and the projection position of the projected image can be automatically adjusted. For example, the specific screen means a screen having a projection region of a predetermined size (for example, aspect ratio of 16:9 or 4:3) and having mark images (the first mark images) at portions of the projection region.

Here, the first mark images on the screen can be formed by attaching, printing and by the other suitable methods, and are preferably formed in a form in which the positions cannot be changed easily.

Moreover, for example, as the first mark images, the circular marks in which white parts (bright parts) and black parts (dark parts) are alternately arranged are used. Each of the white parts and the black parts is alternately arranged in a range formed by dividing the central angle of a circle into a plurality of divisions (for example, quadrisections) and by diving the radius of the circle into a plurality of divisions (for example, approximately bisections) so that the total area of the white parts and the total area of the black parts may be equal to one another.

Hereinafter, various types of kinds of adjustment processing of the projected image in the projection type projector 100 will be described.

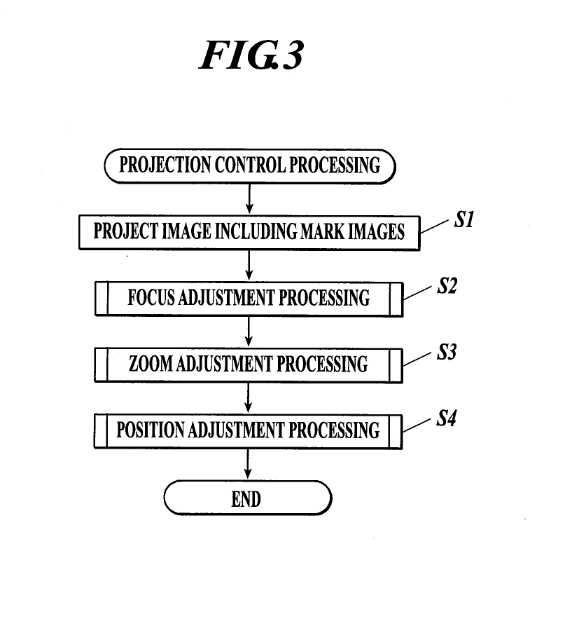

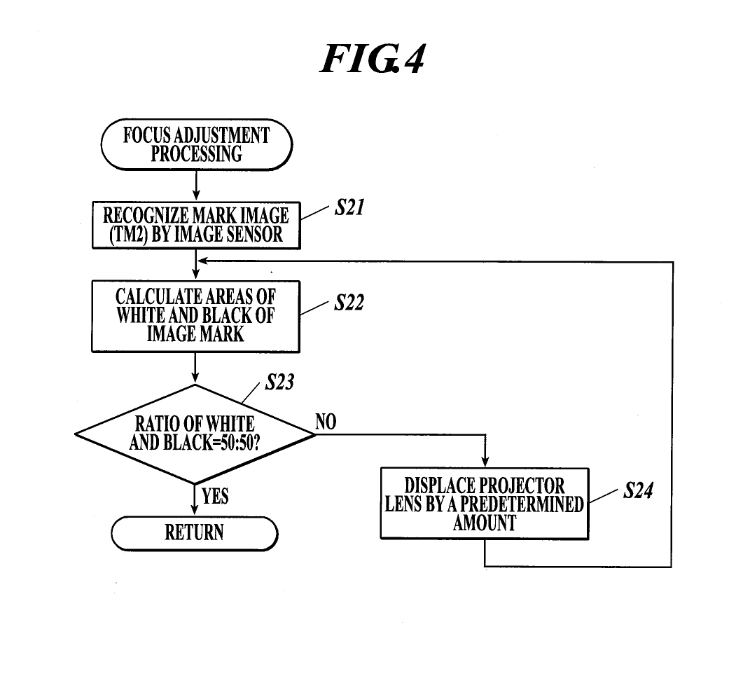

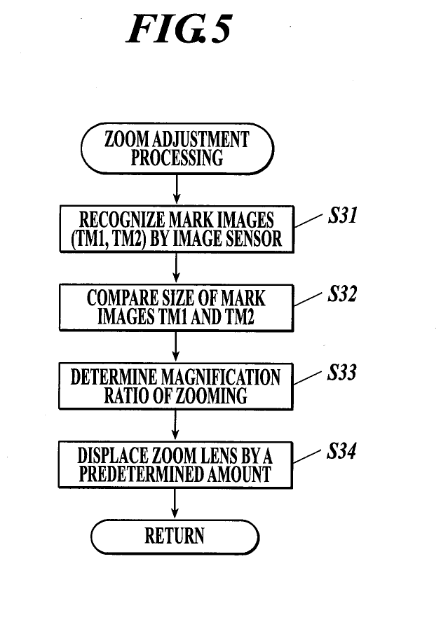

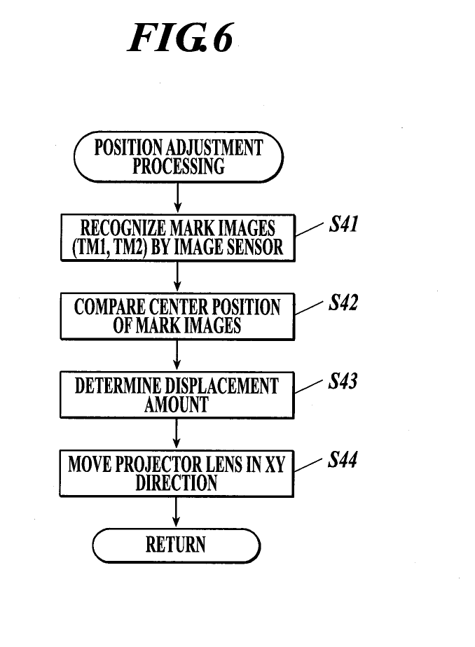

FIG. 3 is a flowchart showing an example of the projection control processing to be executed by the CPU 61 of the projection type projector 100. Moreover, FIG. 4 is a flowchart showing an example of the focus adjustment processing, FIG. 5 is a flowchart showing an example of the zoom adjustment processing and FIG. 6 is a flowchart showing an example of the position adjustment processing.

In FIG. 3, the projection section 1 is made to project an image including the mark images (the second mark images) in step S1. At this time, when the projected image (for example, aspect ratio of 16:9) which is projected by the projection section 1 is displayed and is matched with the projection region (for example, aspect ratio of 16:9) on the screen, the image including the second mark images that match with the first mark images is projected on the screen. That is, the second mark images are also the circular marks in which the white parts and the black parts are alternately arranged in a similar way as in the first mark images. The image data of the second mark images corresponding to the first mark images or the image data of the image including the second mark images are stored in the ROM 63, for example.

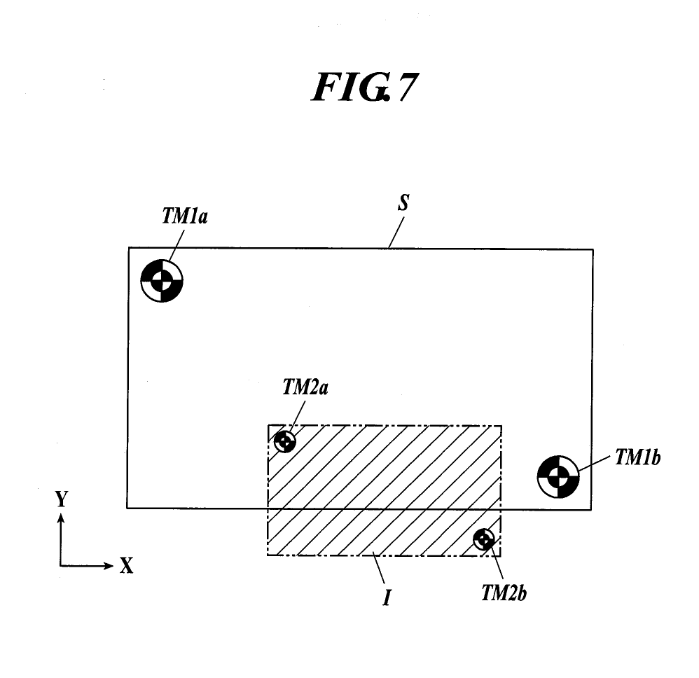

FIG. 7 is an explanatory diagram showing an example of the state where an image including the second mark images is projected on a screen by the projection section 1. FIG. 7 shows the case where the size of the projected image is smaller comparing to the projection region S of the screen and the projection position is shifted to the lower right side of the projection region S.

In the embodiment, various types of adjustments are performed by comparing the first mark images TM1a and TM1b arranged on the screen in advance to the second mark images TM2a and TM2b which are projected images.

Next, in step S2 of FIG. 3, the focus adjustment processing to adjust the focus of the projected image is performed. Particularly, the focus adjustment processing is executed according to the flowchart of FIG. 4.

In FIG. 4, the image which includes the second mark images TM2a and TM2b projected on the screen is taken in through the photographing lens 21, the image which is taken in is picked up by the image sensor 22, and the portion where the second mark images TM2a and TM2b are displayed is extracted from the picked-up image and the second mark images TM2a and TM2b are recognized in step S21.

In step S22, the area of the white parts (bright parts) and the area of the black parts (dark parts) of the second mark images TM2a and TM2b are calculated from the image data picked up by the image sensor 22, and the area ratio is operated.

In step S23, whether the operated area ratio (ratio of the white parts and the black parts) is approximately 50:50 or not is judged. When the ratio is approximately 50:50, it is judges that the projected image is in focus, and the focus adjustment processing is finished. That is, because it is difficult to adjust the focus so that the operated area ratio be just 50:50 depending to the state of the screen, it is considered that the projected image is in focus when the area ratio is within a predetermined range.

On the other hand, when it is judged that the ratio of the white parts and the black parts of the second mark images TM2a and TM2b is off the ratio of 50:50 by a predetermined amount in step S23, the lens drive section 3 is controlled to displace the position of the projector lens 15 by the predetermined amount (Step S24). Then, the focus of the projected image I is adjusted by repeating the steps S22 to S24.

Here when the screen S is placed so that the screen S be accurately perpendicular to the optical axis of the projection light from the projection type projector 100, it is sufficient to perform the focus adjustment to only either one of the second mark images TM2a and TM2b. On the other hand, when the screen S is not perpendicular to the optical axis of the projection light from the projection type projector 100 (for example, in a state where the one second mark image TM2a is in focus and when the other second mark image TM 2b is not in focus), the position of the projector lens 15 is adjusted at the intermediate position between the lens position (adjustment value) where the one second mark image TM2a is in focus and the lens position (adjustment value) where the other second mark image TM2b is in focus. Thereby, the visibility of the entire projected image is improved because almost the center of the projected image is in focus.

After the focus of the projected image is adjusted in the above described manner, the zoom adjustment processing to adjust the size of the projected image to the size of the projection region of the screen is performed in step S3 of FIG. 3. Particularly, the zoom adjustment processing is executed according to the flowchart of FIG. 5.

In FIG. 5, the image including the second mark images TM2a and TM2b projected onto the screen S and the first mark images TM1a and TM1b formed on the screen in advance is taken in through the photographing lens 21, and the image which is taken in by the image sensor 22 is picked up in step S31. Further, the portions where the first mark images TM1a and TM1b and the second mark images TM2a and TM2b are displayed are extracted from the picked-up image and the mark images TM2a and TM2b are recognized. Here, there is no need for the four mark images TM1a, TM1b, TM2a, and TM2b to be taken in at one photographing, and each mark image may be individually photographed, extracted and recognized.

In step S32, the sizes of the first mark images TM1a and TM1b are compared to the sizes of the second mark images TM2a and TM2b corresponding to the first mark images TM1a and TM1b, respectively, on the basis of data of the image picked up by the image sensor 22. For example, the area of the black parts or the white parts is calculated for each of the first mark images TM1a and TM1b and the second mark images TM2a and TM2b.

Then, the magnification ratio of zooming is determined so that the calculated areas may be approximately the same (Step S33), and the lens drive section 3 is controlled on the basis of the determined magnification ratio of zooming to displace the zoom lens by a predetermined amount (Step S34).

Here, when the magnification ratio of zooming is changed so that the size of the one second mark image TM2a be the same size of the corresponding first mark image TM1a, the size of the other second mark image TM2b is not always the same size as the corresponding first mark image TM1b depending on the condition of the screen and the like. In this case, the intermediate value between the magnification ratio of zooming (adjustment value) determined on the basis of the sizes of the mark images TM1a and TM2a and the magnification ratio of zooming (adjustment value) determined on the basis of the sizes of the mark images TM1b and TM2b is set as the magnification ratio of zooming of the projected image. Thereby, the visibility of the entire projected image is improved because the distortion of the projected image caused by the adjustment of zooming is suppressed to the minimum.

Here, when the magnification ratio of zooming is changed so that the size of the second mark image TM2a which is one of the second mark images be the same size as the corresponding first mark image TM1a, the projected image can be matched with the desired projection position on the screen in high accuracy when the size of the other second mark image TM2b is the same size as the corresponding first mark image TM1b.

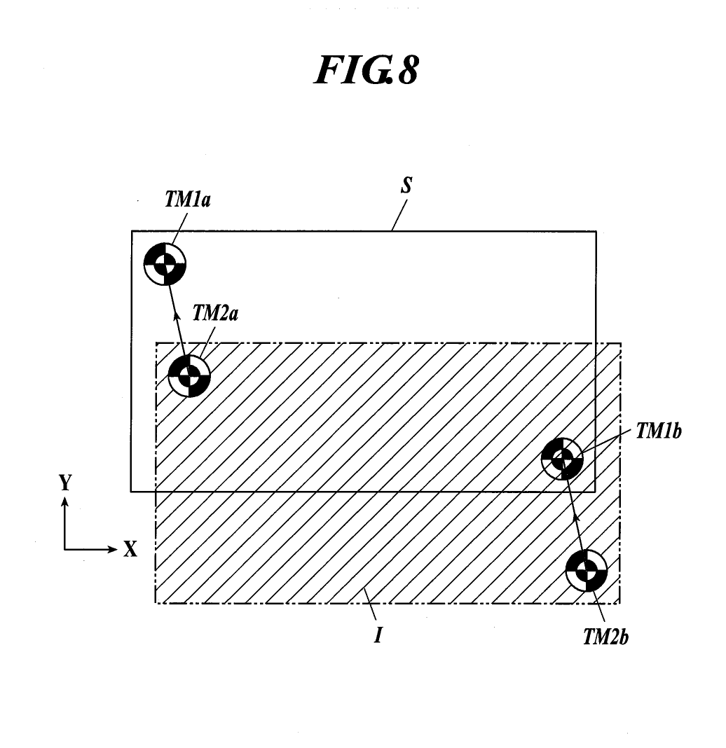

FIG. 8 is an explanatory diagram showing an example of the projected image after the zoom adjustment processing is performed. That is, the size of the entire projected image I becomes the same size as the projection region S of the screen by performing the zoom adjustment processing so that the sizes of the first mark images TM1a and TM1b be the same sizes as the second mark images TM2a and TM2b, respectively, in the state where the image is projected as shown in FIG. 7.

After the size of the projected image is adjusted in the above described manner, the projection position adjustment processing to adjust the projection position of the projected image to the projection region of the screen is performed in step S4 of FIG. 3. Particularly, the projection position adjustment processing is executed according to the flowchart of FIG. 6.

In FIG. 6, the image including the second mark images TM2a and TM2b projected on the screen S and the first mark images TM1a and TM1b which are formed on the screen in advance is taken in through the photographing lens 21, and the image which is taken in is picked up by the image sensor 22 in step S41. Further, the portions where the first mark images TM1a and TM1b and the second mark images TM2a and TM2b are displayed are extracted from the picked-up image and the mark images TM2a and TM2b are recognized.

In step S42, the central coordinates of the first mark images TM1a and TM1b and the second mark images TM2a and TM2b corresponding to the first mark images TM1a and TM1b, respectively, are operated from the data of the image picked up by the image sensor 22, and both of the central coordinates are compared.

Then, the displacement direction and the displacement amount are determined on the basis of the difference of the operated central coordinates (Step S43), and the lens drive section 3 is controlled on the basis of the determined displacement direction and the displacement amount to move the projector lens 15 and the zoom lens 16 in the XY directions (Step S44). That is, the position of the projected image is adjusted by comparing the boundary points of the white parts (bright parts) with the black parts (dark parts) of the first mark images TM1a and TM1b and the second mark images TM2a and TM2b.

Here, when the projection position is changed so that the position (central coordinates) of the one second mark image TM2a match with the position of the corresponding first mark image TM1a, the position of the other second mark image TM2b does not always match with the position of the corresponding first mark image TM1b depending on the condition of the screen and the like. In this case, the intermediate value between the displacement amount (adjustment value) determined on the basis of the difference between the positions of the mark images TM1a and TM2a and the displacement amount (adjustment value) determined on the basis of the difference between the positions of the mark images TM1b and TM2b is set as the displacement amount of the entire projected image. Thereby, because the projected image is displayed at the center of the projection region even when the size of the projected image does not match with the size of the desired projection region of the screen, the visibility of the entire projected image is improved.

Here, when the projection position is changed so that the position of the one second mark image TM2a match with the position of the corresponding first mark image TM1a, the projected image can match with the desired projection region of the screen in high accuracy when the size of the other second mark image TM2b match with the size of the corresponding first mark image TM1b.

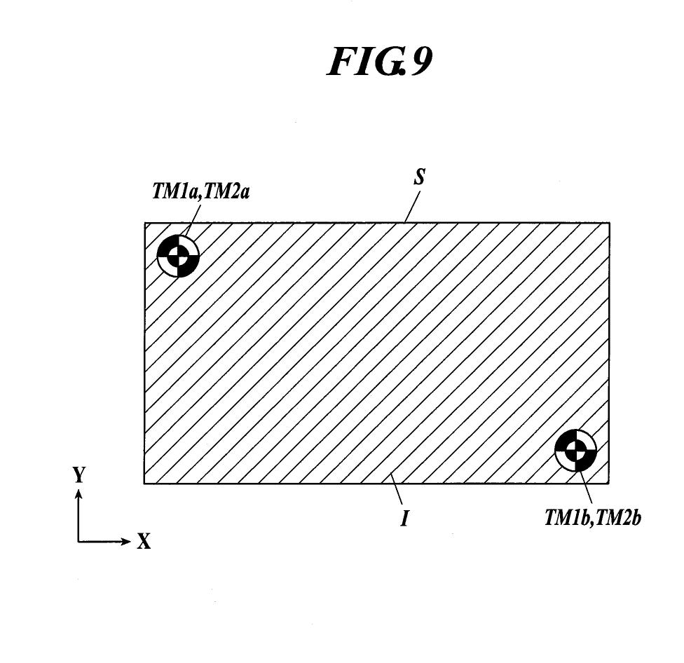

FIG. 9 is an explanatory diagram showing an example of the projected image after the projection position adjustment processing is performed. That is, the projection position of the projected image I matches with the projection region S of the screen by performing the position adjustment processing on the basis of the positions of the first mark images TM1a and TM1b and the second mark images TM2a and TM2b in the state where the image is projected as shown in FIG. 8.

According to the projection type projector 100 of the embodiment, the position, the size and the focus of a projected image can be automatically and accurately adjusted without troubling a user, and a projection type image display apparatus capable of dealing with various situations in such that the kinds of the screens to be used are not limited can be provided.

Moreover, because the size and the projection position of a projected image are adjusted after the focus of the projected image is adjusted on the basis of the photographing result of the second mark images TM2a and TM2b, the size and the projection position can be accurately adjusted.

Moreover, because the mark images TM1a and TM1b attached to the screen S are set as predetermined patterns in advance, it is easy to find the marks by the image recognizing processing. Furthermore, by forming the mark images TM1a and TM1b as patterns in which bright parts and dark parts are alternately arranged, the processing of the confirmation of a shifting amount of the focus, the comparison of sizes and the like becomes extremely easy by the image analysis processing.

In the above, the invention made by the present inventors is described in detail on the basis of the embodiment. However, the present invention is not limited to the above embodiment and can be changed within the scope of the invention.

For example, although the circular register marks have been exemplified as the mark images, a mark in which bright parts and dark parts are alternately arranged in a rectangle like a checkered flag may be adopted, for example, and the other various types of marks can be used.

Moreover, the arrangement and the number of the mark images provided on a screen are not limited to the pattern of the above described embodiment, and for example, the focus adjustment, the adjustment of zooming and the projection position adjustment can be performed easily with only one mark image. Furthermore, when three or more image marks are provided (for example, four marks are provided at the four corners of a projection region), the accuracy in various types of adjustments can be further improved. In addition, the positions and numbers of the marks can be variously changed in such a way that two mark images are provided at the upper center part and the lower center part, and the like.

Moreover, the example of applying the projection method of an image using the DMD is shown in the above embodiment. However, the projection method of an image is not specifically limited, and the method of using a reflection type liquid crystal device may be applied, for example.

Moreover, the configuration in which the projector lens 15 and the zoom lens 16 themselves are displaced in order to perform the focus adjustment, the adjustment of zooming and the projection position adjustment is exemplified. However, a mechanism to move the projection type projector 100 itself into front and back/up and down directions may be provided, and the relative position between the projector lens and the screen may be changed thereby.

According to a first aspect of the preferred embodiment of the present invention, there is provided a projection type image display apparatus comprising a projection section to output a projection light in which an image is attached through a projector lens, a photographing section to photograph a projected image projected by the projection section through a photographing lens, a zoom changing section to change a size of the projected image, a projection position changing section to change a projection position of the projected image and a control section to control the zoom changing section and the projection position changing section to adjust the size and the projection position of the projected image which is projected onto a screen, and when an image is projected on the screen which includes a projection region of a predetermined size and which has a first mark image at a portion of the projection region, the control section controls the projection section so as to project an image which includes a second mark image matching with the first mark image when the projected image is displayed by being matched with the projection region, the control section controls the photographing section so as to photograph the first mark image and the second mark image which is in the projected image, and the control section adjusts the size of the projected image by comparing a size of the first mark image and a size of the second mark image, the first mark image and the second mark image being obtained by the photographing section, and adjusts the projection position of the projected image by comparing a position of the first mark image and a position of the second mark image.

Preferably, the projection type image display apparatus further comprises a lens position changing section to change a lens position of the projector lens so that the projected image is in focus, and the control section controls the lens position changing section to adjust a focus of the projected image, and the control section adjusts the size and the position of the projected image after the lens position changing section adjusts the focus of the projected image on a basis of the second mark image obtained by the photographing section.

Preferably, the first mark image and the second mark image have each pattern where bright parts and dark parts are alternately arranged, the control section adjusts a focus of the projected image by comparing an area of the bright parts to an area of the dark parts for the second mark image obtained by the photographing section, the control section adjusts the size of the projected image by comparing the area of the bright parts of the first mark image to the area of the bright part of the second mark image or by comparing the area of the dark parts of the first mark image to the area of the dark parts of the second mark image, the first mark image and the second mark image being obtained by the photographing section, and the control section adjusts the projection position of the projected image by comparing coordinates of boundary points of the bright parts and the dark parts of the first mark image to coordinates of boundary points of the bright parts and the dark parts of the second mark image, the first mark image and the second mark image being obtained by the photographing section.

Preferably, the first mark image includes two mark images arranged on a diagonal line by having a center of the projection region in between the two mark images, the second mark image includes two mark images arranged on a diagonal line by having a center of the projected image in between the two mark images, and the control section adjusts the size and the position of the projected image by comparing the first mark image and the second mark image for each of the two mark images.

Preferably, the control section adjusts the size and the projection position of the projected image on a basis of a center value of an adjustment value calculated for each of the two mark images.

According to a second aspect of the preferred embodiment of the present invention, there is provided a projection type image display apparatus comprising a projection section to output a projection light in which an image is attached through a projector lens, a photographing section to photograph a projected image projected by the projection section through a photographing lens, a zoom changing section to change a size of the projected image, a projection position changing section to change a projection position of the projected image, a lens position changing section which can change a lens position of the projector lens so that the projected image is in focus and a control section to control the zoom changing section, the projection position changing section and the lens position changing section to adjust the size, the projection position and a focus of the projected image projected on a screen, and when an image is projected on the screen which includes a projection region of a predetermined size and in which two first mark images have each pattern where bright parts and dark parts are alternately arranged are provided on a diagonal line by having a center of the projection region in between the two first mark images, the control section controls the projection section so as to project an image which includes a second mark image matching with the first mark image when the projected image is displayed by being matched with the projection region, the control section controls the photographing section so as to photograph the first mark image and the second mark image which are in the projected image, the control section adjusts the size of the projected image by comparing the area of the bright parts of the first mark image to the area of the bright part of the second mark image or by comparing the area of the dark parts of the first mark image to the area of the dark parts of the second mark image, the first mark image and the second mark image being obtained by the photographing section, and the control section adjusts the projection position of the projected image by comparing coordinates of boundary points of the bright parts and the dark parts of the first mark image to coordinates of boundary points of the bright parts and the dark parts of the second mark image, the first mark image and the second mark image being obtained by the photographing section.

According to a third aspect of the preferred embodiment of the present invention, there is provided a projection type image display system comprising a projection type image display apparatus comprising a projection section to output a projection light in which an image is attached through a projector lens, a photographing section to photograph a projected image projected by the projection section through a photographing lens, a zoom changing section to change a size of the projected image, a projection position changing section to change a projection position of the projected image and a control section to control the zoom changing section and the projection position changing section to adjust the size and the projection position of the projected image projected onto a screen and the screen which includes a projection region of a predetermined size and which has a first mark image at a portion of the projection region, and the control section controls the projection section so as to project an image which includes a second mark image matching with the first mark image when the projected image is displayed by being matched with the projection region, the control section controls the photographing section so as to photograph the first mark image and the second mark image which is in the projected image, and the control section adjusts the size of the projected image by comparing a size of the first mark image to a size of the second mark image, the first mark image and the second mark image being obtained by the photographing section, and adjusts the projection position of the projected image by comparing a position of the first mark image to a position of the second mark image.

According to the present invention, a projection type image display apparatus which is capable of automatically and accurately adjusting the position, the size, and the focus of a projected image without troubling a user and which is capable of accommodating various situations in such that the kinds of screens to be used is not limited can be provided.

The entire disclosure of Japanese Patent Application No. 2007-135523 filed on May 22, 2007 including description, claims, drawings, and abstract are incorporated herein by reference in its entirety.

Although various exemplary embodiments have been shown and described, the invention is not limited to the embodiment shown. Therefore, the scope of the invention is intended to be limited solely by the scope of the claims that follow.

What is claimed is:

1. A projection type image display apparatus, comprising:
a projection section to output a projection light in which an image is attached through a projector lens;
a photographing section to photograph a projected image projected by the projection section through a photographing lens;
a zoom changing section to change a size of the projected image;
a projection position changing section to change a projection position of the projected image; and
a control section to control the zoom changing section and the projection position changing section to adjust the size and the projection position of the projected image which is projected onto a screen, wherein
when an image is projected on the screen which includes a projection region of a predetermined size and which has a first mark image at a portion of the projection region,
the control section controls the projection section so as to project an image which includes a second mark image matching with the first mark image when the projected image is displayed by being matched with the projection region,
the control section controls the photographing section so as to photograph the first mark image and the second mark image which is in the projected image, and
the control section adjusts the size of the projected image by comparing a size of the first mark image and a size of the second mark image, the first mark image and the second mark image being obtained by the photographing section, and adjusts the projection position of the projected image by comparing a position of the first mark image and a position of the second mark image.

2. The projection type image display apparatus as claimed in claim 1, further comprising a lens position changing section to change a lens position of the projector lens so that the projected image is in focus, wherein
the control section controls the lens position changing section to adjust a focus of the projected image, and the control section adjusts the size and the position of the projected image after the lens position changing section adjusts the focus of the projected image on a basis of the second mark image obtained by the photographing section.

3. The projection type image display apparatus as claimed in claim 1, wherein
the first mark image and the second mark image have each pattern where bright parts and dark parts are alternately arranged,
the control section adjusts a focus of the projected image by comparing an area of the bright parts to an area of the dark parts for the second mark image obtained by the photographing section,
the control section adjusts the size of the projected image by comparing the area of the bright parts of the first mark image to the area of the bright part of the second mark image or by comparing the area of the dark parts of the first mark image to the area of the dark parts of the second mark image, the first mark image and the second mark image being obtained by the photographing section, and
the control section adjusts the projection position of the projected image by comparing coordinates of boundary points of the bright parts and the dark parts of the first mark image to coordinates of boundary points of the bright parts and the dark parts of the second mark image, the first mark image and the second mark image being obtained by the photographing section.

4. The projection type image display apparatus as claimed in claim 1, wherein
the first mark image includes two mark images arranged on a diagonal line by having a center of the projection region in between the two mark images,
the second mark image includes two mark images arranged on a diagonal line by having a center of the projected image in between the two mark images, and
the control section adjusts the size and the position of the projected image by comparing the first mark image and the second mark image for each of the two mark images.

5. The projection type image display apparatus as claimed in claim 4, wherein
the control section adjusts the size and the projection position of the projected image on a basis of a center value of an adjustment value calculated for each of the two mark images.

6. A projection type image display apparatus comprising:
a projection section to output a projection light in which an image is attached through a projector lens;
a photographing section to photograph a projected image projected by the projection section through a photographing lens;
a zoom changing section to change a size of the projected image;
a projection position changing section to change a projection position of the projected image;
a lens position changing section which can change a lens position of the projector lens so that the projected image is in focus; and
a control section to control the zoom changing section, the projection position changing section and the lens position changing section to adjust the size, the projection position and a focus of the projected image projected on a screen, wherein
when an image is projected on the screen which includes a projection region of a predetermined size and in which two first mark images have each pattern where bright parts and dark parts are alternately arranged are provided on a diagonal line by having a center of the projection region in between the two first mark images,
the control section controls the projection section so as to project an image which includes a second mark image matching with the first mark image when the projected image is displayed by being matched with the projection region,
the control section controls the photographing section so as to photograph the first mark image and the second mark image which are in the projected image,
the control section adjusts the size of the projected image by comparing the area of the bright parts of the first mark image to the area of the bright part of the second mark image or by comparing the area of the dark parts of the first mark image to the area of the dark parts of the second mark image, the first mark image and the second mark image being obtained by the photographing section, and
the control section adjusts the projection position of the projected image by comparing coordinates of boundary points of the bright parts and the dark parts of the first mark image to coordinates of boundary points of the bright parts and the dark parts of the second mark image, the first mark image and the second mark image being obtained by the photographing section.

7. A projection type image display system, comprising:
a projection type image display apparatus comprising a projection section to output a projection light in which an image is attached through a projector lens, a photographing section to photograph a projected image projected by the projection section through a photographing lens, a zoom changing section to change a size of the projected image, a projection position changing section to change a projection position of the projected image and a control section to control the zoom changing section and the projection position changing section to adjust the size and the projection position of the projected image projected onto a screen; and
the screen which includes a projection region of a predetermined size and which has a first mark image at a portion of the projection region, wherein
the control section controls the projection section so as to project an image which includes a second mark image matching with the first mark image when the projected image is displayed by being matched with the projection region,
the control section controls the photographing section so as to photograph the first mark image and the second mark image which is in the projected image, and
the control section adjusts the size of the projected image by comparing a size of the first mark image to a size of the second mark image, the first mark image and the second mark image being obtained by the photographing section, and adjusts the projection position of the projected image by comparing a position of the first mark image to a position of the second mark image.
